(19) United States
(12) Patent Application Publication
(10) Pub. No.: US 2005/0215695 A1
(43) Pub. Date: Sep. 29, 2005

(54) Stabilized flame retardant additives and their use

(76) Inventors: Danielle F. Goossens, Nodebais (BE); Dominique Fasbinder, Braives (BE)

Correspondence Address: EDGAR SPIELMAN;ALBEMARLE CORPORATION, 451 FLORIDA BLVD., BATON ROUGE, LA, 70801, US

(21) Appl. No.: 10/813,513

(22) Filed: Mar. 29, 2004

(51) Int. Cl. C08K 3/00

(52) U.S. Cl. 524/464

(57) ABSTRACT

A relatively small amount of at least one thermoplastic acrylate or methacrylate polymer that melts within the range of about 50 to about 150° C., is combined with at least one bromine-containing flame retardant that has at least 4 carbon atoms in the molecule, a total bromine content of at least about 40 wt %, and at least two bromine atoms in the molecule directly bonded to one or more aliphatic or cycloaliphatic carbon atoms. Such combination provides a composition having a higher thermal stability as compared to the same flame retardant in the absence of such acrylate or methacrylate polymer. This improvement in thermal stability exists when the components are provided as an additive or when the components have been blended in a thermoplastic polymer such as styrenic polymer.

### TECHNICAL FIELD

This invention relates to improving the thermal stability of flame retardants that have bromine atoms attached directly to one or more aliphatic or cycloaliphatic carbon atom in the molecule, such as for example, 1,2,5,6-tetrabromocyclooctane (hereinafter often referred to as tetrabromocyclooctane) and 1,2-dibromo-4-(1,2-dibromoethyl)cyclohexane (hereinafter often referred to as dibromoethyl-dibromocyclohexane). This invention also relates to use of the resultant flame retardant/thermal stabilizer combinations in the production of flame retardant olefinic polymers such as polyethylene and polypropylene, or styrenic polymers such as GPPS, MIPS, HIPS, XPS and EPS.

### BACKGROUND

Flame retardants in which bromine atoms are directly bonded to aliphatic or cycloaliphatic moieties in the molecule are known substances useful in flame retarding polymers of various types. Although such flame retardants are effective for this use, their thermal stability is in many cases a substantial drawback.

Heretofore, proposals have been made to provide compositions in which an aliphatic or cycloaliphatic bromine flame retardant could be thermally stabilized by use of certain additives. Unfortunately, such compositions usually are too expensive for serious consideration on a commercial basis not environmentally favorable. It would thus be of considerable advantage if a new cost-effective environmentally-friendly way could be found for increasing the thermal stability of flame retardants in which bromine atoms are directly bonded to aliphatic or cycloaliphatic moieties in the molecule. If possible, it would be highly advantageous if the stabilizer system could not only be a relatively low-cost system, but additionally if the system could enable achievement of superior cost-effectiveness in flame retardancy and/or thermal stability.

This invention is deemed to provide at least one or more, if not all, of the foregoing advantages.

### BRIEF SUMMARY OF THE INVENTION

Pursuant to this invention, a relatively small amount of at least one thermoplastic acrylate or methacrylate polymer that melts within the range of about 50 to about 150° C., is combined with at least one bromine-containing flame retardant that has at least 4 carbon atoms in the molecule, that has a total bromine content of at least about 40 wt %, and that has at least two bromine atoms in the molecule directly bonded to one or more aliphatic or cycloaliphatic carbon atoms. Such combination provides a composition having a higher thermal stability as compared to the same flame retardant in the absence of such acrylate or methacrylate polymer. The flame retardants used in the practice of this invention are in general (i) bromoaliphatic compounds, (ii) bromocycloaliphatic compounds, or (iii) substituted aromatic compounds having bromine atoms on at least one aliphatic or cycloaliphatic portion of the molecule.

Thus pursuant to one of its embodiments, this invention provides a flame retardant additive composition having enhanced thermal stability which comprises a blend of, or composition formed from, (A) at least one bromine-containing flame retardant that has at least 4 carbon atoms in the molecule, that has a total bromine content of at least about 40 wt %, and that has at least two bromine atoms in the molecule directly bonded to one or more aliphatic or cycloaliphatic carbon atoms, and a thermal stabilizing amount of (B) at least one thermoplastic acrylate or methacrylate polymer that melts within the range of about 50 to about 150° C.

A further embodiment of this invention is a flame retardant polymer composition comprised of at least one thermoplastic styrenic or olefinic polymer with which has been blended a flame retardant amount of (A) at least one bromine-containing flame retardant that has at least 4 carbon atoms in the molecule, that has a total bromine content of at least about 40 wt %, and that has at least two bromine atoms in the molecule are directly bonded to one or more aliphatic or cycloaliphatic carbon atoms, and a thermal stabilizing amount of (B) at least one thermoplastic acrylate or methacrylate polymer that melts within the range of about 50 to about 150° C. In this embodiment, the styrenic polymer can be a general purpose styrenic polymer such as GPPS, an impact modified styrenic polymer (IPS), such as MIPS and HIPS, or a styrenic polymer foam composition such as XPS or EPS. The thermoplastic olefinic polymer can be formed from one or more olefinic monomers, and can be a totally hydrocarbonaceous olefin polymer or it can contain suitable functional substituents in the molecule.

One of the features of this invention is that the one or more thermoplastic acrylate or methacrylate polymers used as component (B) in the compositions of this invention take on a new function which, so far as is known, has never been deemed possible heretofore. In particular, the thermoplastic acrylate or methacrylate polymer or combination of acrylate and/or methacrylate polymers used as component (B) serves as a thermal stabilizer for the flame retardant additive composition or the thermoplastic styrenic or olefinic polymer composition in which components (A) and (B) have been incorporated. Thus in such flame retardant additive compositions, components (A) and (B) are preferably in proportions such that the additive composition has a greater thermal stability than the same amount of the same bromine-containing flame retardant by itself. Likewise, in a flame retardant polymer composition comprised of (i) a thermoplastic styrenic or olefinic polymer, (ii) component (A), and (iii) component (B), components (A) and (B) preferably are proportioned relative to each other such that this thermoplastic styrenic or olefinic polymer composition has a greater thermal stability than the same polymer composition except that component (B) is omitted therefrom. Thermal stabilities are best determined by use of dynamic thermogravimetric analysis (TGA).

A preferred embodiment of this invention is a composition comprising a foamed or expanded styrenic polymer in which has been included a flame retardant quantity of the above component (A) and a thermal stabilizing amount of the above component (B).

Yet another preferred embodiment of this invention is a polymer composition of this invention comprised of at least one impact modified styrenic polymer in which has been included a flame retardant quantity of the above components (A) and (B). The impact modified styrenic polymer is preferably an impact modified polystyrene such as MIPS and more preferably impact modified polystyrene such as HIPS.

A further embodiment is a formulation suitable for use in producing expanded, i.e., foamed articles, from a styrenic polymer, which formulation comprises at least a styrenic monomer or polymer, a flame retardant quantity of component (A) and a thermal stabilizing quantity of component (B), and at least one blowing agent.

Still another embodiment of this invention is a method for thermally stabilizing at least one bromine-containing flame retardant that has at least 4 carbon atoms in the molecule, that has a total bromine content of at least about 40 wt %, and that has at least two bromine atoms in the molecule directly bonded to one or more aliphatic or cycloaliphatic carbon atoms. Such method comprises blending with such flame retardant(s) a thermal stabilizing amount of at least one thermoplastic acrylate or methacrylate polymer that melts within the range of about 50 to about 150° C.

The use of at least one thermoplastic acrylate or methacrylate polymer that melts within the range of about 50 to about 15° C. to thermally stabilize at least one bromine-containing flame retardant that has at least 4 carbon atoms in the molecule, that has a total bromine content of at least about 40 wt %, and that has at least two bromine atoms in the molecule directly bonded to one or more aliphatic or cycloaliphatic carbon atoms constitutes still another embodiment of this invention. Typically, this use is effected by blending together (1) at least one such flame retardant and (2) at least one thermoplastic acrylate or methacrylate polymer that melts within the range of about 50 to about 150° C., or by forming a blend of (1) at least one such flame retardant, (2) at least one such thermoplastic acrylate or methacrylate polymer, and (3) at least one styrenic or olefinic polymer.

Especially preferred embodiments of this invention enable achievement of still other highly advantageous results. In these especially preferred embodiments another component, component (C), is included in the additive and styrenic or olefinic compositions of this invention such as are described above. In these embodiments component (C) is either (a) at least one zeolite, (b) at least one hydrotalcite, or (c) at least one tin stabilizer, or (d) a combination of any two or all three of (a), (b), and (c). Use of component (C) in the practice of the various embodiments of this invention can provide synergistically enhanced results such that (a) higher flame retardant effectiveness can be achieved as compared to the corresponding composition devoid of component (C), and/or lower bromine loadings can be used in flammable thermoplastic styrenic or olefinic polymer substrates without loss of flame retardant effectiveness. Also, the zeolite and/or hydrotalcite and/or tin stabilizer can contribute to the thermal stability of the overall composition. The use of components (A), (B), and (C) in, and the incorporation of components (A), (B), and (C) into, styrenic and olefinic polymers, and the resultant olefinic or styrenic polymer compositions, constitute still further embodiments of this invention.

In other embodiments of this invention only components (A) and (B) are included in the flame retardant additive compositions and thermoplastic styrenic or olefinic polymer compositions of this invention, i.e., in such embodiments these particular flame retardant additive or flame retardant polymer compositions contain no other deliberately added components. Only ordinary impurities and manufacturing by-products or the like are present in the additive compositions of this embodiment of the invention.

In still further embodiments of this invention, any of the flame retardant additive compositions of this invention are in pelletized form. This facilitates incorporation of the additive composition in the thermoplastic polymer substrates to be flame retarded pursuant to this invention.

Other embodiments of this invention will be still further apparent from the ensuing description and appended claims.

### FURTHER DETAILED DESCRIPTION OF THE INVENTION

Component (A)

This invention is applicable to the thermal stabilization of any of a wide variety of flame retardants in which bromine is directly bonded to at least one aliphatic or cycloaliphatic moiety. Thus, the flame retardant has at least 4 carbon atoms in the molecule, a total bromine content of at least about 40 wt %, and at least two bromine atoms in the molecule directly bonded to one or more aliphatic or cycloaliphatic carbon atoms. Preferred flame retardants contain at least 6 carbon atoms in the molecule, a total bromine content of at least about 50 wt %, and at least 4 bromine atoms in the molecule directly bonded to aliphatic or cycloaliphatic carbon atoms. Particularly preferred flame retardants contain at least 8 carbon atoms in the molecule, a total bromine content of at least about 60 wt %, and at least 4 bromine atoms in the molecule directly bonded to aliphatic or cycloaliphatic carbon atoms. In general, the bromine-containing flame retardant compounds as described above can be (a) aliphatic (i.e., open chain) compounds, (b) alicyclic compounds (i e., non-aromatic compounds having in the molecule one or more non-aromatic cyclic moieties and which, optionally, can also have one or more aliphatic (open chain) moieties in the molecule), or (c) aromatic compounds having either or both of homocyclic aromaticity and heterocyclic aromaticity and which have one or more aliphatic moieties and/or alicyclic moieties in the molecule. Whichever the configuration, the flame retardant compound is by definition capable of being used in the substrate polymer and to provide flame retardancy therein. Preferably the flame retardant compounds used as component (A) contain only carbon, hydrogen, bromine, and optionally chlorine, nitrogen, phosphorus, oxygen, and/or sulfur atoms in the molecule, and most preferably only carbon, hydrogen, bromine, and optionally oxygen atoms in the molecule.

Non-limiting examples of suitable flame retardants include tetrabromobutane, hexabromocyclododecane, pentabromochlorocyclohexane, N,N′-ethylenebis(5,6-dibromo-2,3-norbornane dicarboximide), dibromoethyldibromocyclohexane, tetrabromocyclooctane, tris(2,3-dibromopropyl)isocyanurate, the bis(2,3-dibromopropyl ether) of tetrabromobisphenol-A, the bis(2,3-dibromopropyl ether) of tetrabromobisphenol-S, brominated paraffins (e.g., having in the range of about 6 to about 36 atoms in the molecule), tribromoneopentyl alcohol, tris(tribromoneopentyl)phosphate, and the bis(2,3-dibromopropylester) of tetrabromophthalic acid.

Further examples of such brominated compounds may be found for example in U.S. Pat. Nos. 3,761,443; 3,786,023; 3,864,306; 3,899,463; 3,903,109; 3,917,642; 3,922,316; 3,923,734; 3,950,456; 4,067,930; 4,127,556; and 4,430,467 which are fully incorporated herein by reference. Of the various brominated compounds to be stabilized pursuant to this invention, tetrabromocyclooctane and dibromoethyl-dibromocyclohexane are preferred. Tetrabromocyclooctane is available commercially from Albemarle Corporation as SAYTEX® BC-48 flame retardant. Dibromoethyl-dibromocyclohexane is available commercially from Albemarle Corporation as SAYTEX® BCL-462 flame retardant.

Component (B)

In the practice of this invention, one or more acrylate polymers or one or more methacrylate polymers or a combination of at least one acrylate polymer and at least one methacrylate polymer are used primarily as stabilizers. The acrylate or methacrylate polymers used typically will melt in the range of about 50 to about 150° C. In general, when the bromine-containing flame retardant melts at temperatures of about 95-100° C. or higher, it is preferred that the melting point of the acrylate or methacrylate polymer used be within about 30° C. of the melting point of the bromine-containing flame retardant used in accordance with this invention. With solid bromine-containing flame retardants that melt at temperatures below about 95° C., it is preferred that the melting point of the polymer used be within about 20° C., and more preferably within about 10° C., of the melting point of the bromine-containing flame retardant used in accordance with this invention. In cases where either component (A) or component (B) does not have a reasonably sharp melting point, the temperature at which such component becomes soft and pliable can be used as a guide in lieu of a melting point. Thus when the flame retardant used is tetrabromocyclooctane which melts at about 100° C., such acrylate or methacrylate polymer or combination of such polymers used preferably melts in the range of about 70 to about 130° C., but more preferably melts in the range of about 80 to about 120° C., and still more preferably melts in the range of about 90 to about 110° C. Similarly, when the flame retardant used is dibromoethyl-dibromocyclohexane which melts at about 70° C., preferably such polymer or combination of such polymers used melts in the range of about 40 to about 100° C., and more preferably within the range of about 50 to about 90° C., and most preferably in the range of about 60 to about 80° C. If a combination of tetrabromocyclooctane and dibromoethyl-dibromocyclohexane is used, the polymer or combination of such polymers used most preferably melts in the range of about 60 to about 90° C.

While homopolymers with appropriate melting temperatures can be used, the presently-preferred polymers are ethylene/acrylate or ethylene/methacrylate copolymers or terpolymers that melt within the range given above. Among classes of terpolymers having members with suitable melting temperatures are ethylene-methyl acrylate copolymers, ethylene-ethyl acrylate copolymers, ethylene-propyl acrylate copolymers, ethylene-butyl acrylate copolymers, ethylene-propyl acrylate-carbon monoxide copolymers, ethylene-butyl acrylate-carbon monoxide copolymers, ethylene-methyl acrylate-maleic anhydride terpolymers, ethylene-ethyl acrylate-maleic anhydride terpolymers, ethylene-propyl acrylate-maleic anhydride terpolymers, ethylene-butyl acrylate-maleic anhydride terpolymers, ethylene-methyl acrylate-glycidyl methacrylate terpolymers, and similar copolymers and terpolymers having suitable melting temperatures. A number of suitable polymers are available from different sources as articles of commerce. A few non-limiting examples of such commercially-available polymers include a number of ethylene-methylacrylate copolymers and ethylene-n-butylacrylate copolymers available from Atofina Chemicals, Philadelphia, Pa., under the trademark LOTRYL, a number of ethylene-ethylacrylate-maleic anhydride terpolymers and ethylene-n-butylacrylate-maleic anhydride terpolymers available from Atofina Chemicals under the trademark LOTADER, and a number of ethylene-butylacrylate-carbon monoxide copolymers available from DuPont Packaging & Industrial Polymers, Wilmington, Del., under the trademark ELVALOY. Of the foregoing polymers, copolymers of ethylene, at least one C₁₋₄alkyl acrylate that melt within the range of about 55 to about 140° C., and terpolymers of ethylene, at least one C₁₋₄alkyl acrylate, and glycidyl methacrylate that melt within the range of about 50 to about 120° C. are preferred. Particularly preferred are ethylene-ethyl acrylate copolymers that melt within the range of about 60 to about 110° C. and ethylene-methylacrylate-glycidyl methacrylate terpolymers that melt within the range of about 60 to about 115° C.

Component (C)

Any of a variety of zeolites, hydrotalcites, or tin stabilizers, or any two or more of which can be used in the preferred embodiments of this invention in which one or more such additional components are employed. Other stabilizers like metal stearates and inorganic phosphates can also be used but most preferred are hydrotalcites, tin containing stabilizers and zeolites. The presence of such additives in a thermoplastic polymer composition of this invention can increase the flame retardancy effectiveness of Component (A) such that one can either utilize such increased effectiveness at a given level of Component (A) or reduce the level of Component (A) to achieve the flame retardant effectiveness ordinarily given by a higher level of Component (A) in the absence of Component (C).

A variety of natural or synthetic zeolites can be used as component (C). Of these, synthetic zeolites are preferred, and include the following: Zeolites A, X, M, F, B, H, J, W, Y, and L described respectively in U.S. Pat. Nos. 2,822,243; 2,822,244; 2,995,423; 2,996,358; 3,008,803; 3,010,789; 3,011,869; 3,102,853; 3,130,007; and 3,216,789, respectively. Still other synthetic zeolites are known, such as ZSM-5, and these can be used. In all cases, the zeolite should be used in the form of a fine dry powder, free of lumps or clumps. From the cost-effectiveness standpoint zeolite-A is a preferred material. In a preferred embodiment, the selected zeolite is calcined before use in order to reduce its water content without materially disrupting its physical structure or average pore size. For example, zeolite-A typically contains about 18.5% water, and calcining can prove useful in reducing this water content, thereby increasing its usefulness in the compositions of this invention. Other zeolites such as zeolite-X which typically contains about 24% water, and zeolite-Y which has a typical water content of about 25% may also be improved for use in this invention by calcining them prior to use to reduce their water contents but without destroying their structure. An advantage of zeolite ZSM-5 is its normal low content of water, about 5%.

Suitable hydrotalcites for use in this invention include those represented by the general formula:
M²⁺₁₋ₓM³⁺ₓ(OH)₂(Aⁿ⁻)_{x/n}mH₂O
wherein M²⁺ is selected from the group consisting of Mg²⁺, Ca²⁺, Sr²⁺, Ba²⁺, Zn²⁺, Cd²⁺, Pb²⁺, Sn²⁺, or Ni²⁺; M³⁺=Al³⁺, B³⁺or Bi³⁺; Aⁿ⁻ is an anion having a valence of n, preferably selected from the group consisting of OH⁻, Cl⁻, Br⁻, I⁻, ClO₄⁻, HCO₃⁻, CH₃COO⁻, C₆H₅COO⁻, CO₃²⁻, SO₄²⁻, (COO⁻)₂, (CHOH)₄CH₂OHCOO⁻, C₂H₄(COO)₂²⁻, (CH₂COO)₂²⁻, CH₃CHOHCO⁻, SiO₃²⁻, SiO₄⁴⁻, Fe(CN)₆³⁻, Fe(CN)₆⁴⁻ or HPO₄²⁻; n is from about 1 to about 4; x is from about 0 to about 0.5; and m is from about 0 to about 2. Preferably, M²⁺ is Mg²⁺ or a solid solution of Mg and Zn, M³⁺ is Al³⁺; Aⁿ⁻ is CO₃²⁻, x is a number from 0 to 0.5, and m is a number from 0 to 2.

Exemplary hydrotalcites include, but are not necessarily limited to: Al₂O₃.6MgO.CO₂.12H₂O; Mg_{4.5}Al₂(OH)₁₃.CO₃.3-5H₂O; 4MgO.Al₂O₃CO₂.9H₂O; 4MgO.Al₂O₃.CO₂.6H₂O; ZnO.3MgO.Al₂O₃. CO₂.8-9H₂O and ZnO.3MgO.Al₂O₃.CO₂.5-6H₂O.

Hydrotalcites are commercially available from Kyowa Chemical Company under the trade designations DHT-4A, DHT-4C and DHT-4V, and from J. M. Huber Corporation under the trade designations Hysafe 539 and Hysafe 530. DHT-4A hydrotalcite has been found especially useful in further increasing flame retardancy.

At least one tin-containing stabilizer, preferably an organotin stabilizer compound, can also be used as component (C). A variety of tin compounds are available for such use. These include, for example, dibutyltin dilaurate; dibutyltin maleate, dibutyltin bis(n-alkyl maleate) wherein the alkyl group typically has in the range of about 4 to about 8 carbon atoms; dibutyltin bis(lauryl mercaptide); thiabisbutyltin sulfide; dibutyltin sulfide; dimethyltin bis(isooctylmercaptoacetate), and the analogous dibutyltin- and di-n-octyltin-derivatives thereof; dimethyltin bis(β-alkanoyloxyethylmercaptide); alkyltin mercaptoalkanoates such as dibutyltin-β-mercaptopropionate, dibutyltin-β-mercaptopropionate, thiabismonomethyltin bis(β-alkanoyloxyethylmercaptide); alkyltin mercaptides of the formula R₂Sn(SR′)₂, such as those in which each R is an alkyl group that contains about 4 to about 8 carbon atoms and each R′ is an alkyl group that contains about 8 to about 14 carbon atoms, e.g., dibutyltin bis(dodecylmercaptide). On the foregoing tin-containing stabilizers, dibutyl tin maleate is preferred. Stann B M from Sankyo has been used in the examples. Other suppliers like Akcros and Carlocher also offer this material under trade names Tinstab BM360 or Barostab MS.

Mixtures of two or more of (a) at least one zeolite, preferably a synthetic zeolite, (b) at least one hydrotalcite, or (c) at least one tin stabilizer can also be used.

Preferably component (C) is in powder or other very finely-divided form so that it can be readily dispersed with the other components being used.

Substrate Thermoplastic Polymers

The thermoplastic polymer compositions to which this invention is especially adapted are thermoplastic polymers having polymerized ethylenic linkages. By this is meant that the structure of the polymer includes polymer units formed from one or more monomers having a polymerizable terminal CH₂═CR— group which enters into the formation of the polymer. Such polymers are typified by (i) polyolefin polymers, (ii) styrenic polymers (also known as vinylaromatic polymers), (iii) functionally-substituted alpha-olefin polymers, and (iv) elastomers derived at least in part from diene monomers copolymerized with one or more monomers of (i), (ii), and/or (iii). Polyolefin polymers are formed by homopolymerization or copolymerization of alpha-olefin monomers having in the range of 2 to about 10 carbon atoms, non-limiting examples of which polymers are polyethylene, polypropylene, polybutene, polyisobutylene, and copolymers such as ethylene-propylene copolymers, and ethylene copolymerized with one or more such monomers as 1-pentene, 3-methyl-1-butene, 1-hexene, 4-methyl-1-pentene, 1-heptene, 1-octene, 1-decene or analogs thereof. The styrenic polymers are homopolymers or copolymers formed from vinylaromatic monomers having 8 to about 16 carbon atoms per molecule, such as styrene, 2-methylstyrene, 3-methylstyrene, 4-methylstyrene, 2,4-dimethylstyrene, alpha-methylstyrene, 4-tert-butyl-styrene, 3,5-diethylstyrene, 2,4,5-trimethylstyrene, vinylnaphthalene, or analogs thereof. Functionally-substituted alpha-olefin polymers which may be used in the practice of this invention are copolymers of at least one 1-olefin and/or styrenic monomer and at least one copolymerizable carboxylic acid, carboxylic acid ester and/or nitrile, non-limiting examples of which include ethylene-acrylic acid copolymer, ethylene-vinylacetate copolymer, ethylene-acrylonitrile copolymer, ABS, MABS, SAN, and similar materials. Elastomers derived at least in part from polymerized diene monomers which may be used in the practice of this invention include elastomeric terpolymers of ethylene, propylene, and at least one diene such as norbornadiene or hexadiene, butadiene-styrene elastomers, butadiene-acrylonitrile elastomers, and similar materials.

Polyolefin polymers can be, for example, homopolymers of ethylene, propylene, butene or higher alpha-olefins; copolymers of ethylene or propylene with one or more higher alpha-olefins such as 1-pentene, 3-methyl-1-butene, 1-hexene, 4-methyl-1-pentene, 1-heptene, 1-octene, 1-decene; or copolymers of ethylene, propylene and a third monomer such as a diene. One or more other additives can be present in such polymer compositions as long as such other additives do not materially detract from the results obtained when using only the same levels of components (A) and (B). However, in an embodiment of this this invention the foregoing polymer composition is devoid of any other flame retardant and any other thermal stabilizer component.

The additive compositions of this invention can also be used in polymer blends containing substantial proportions of one or more styrenic polymers such as polyphenylene ether/polystyrene, polyphenylene ether/HIPS, or aromatic polycarbonate/ABS blends.

Preferred polymer compositions of this invention are styrenic polymers with which Components (A) and (B), and especially Components (A), (B) and (C), are blended. These compositions optionally contain still other components. Additive Components (A), (B), and, when used, Component (C), are preferably used as a preformed additive composition in pelletized form. The styrenic polymer used can be a general purpose styrenic polymer such as GPPS, an impact modified styrenic polymer (IPS), such as MIPS and HIPS, or a styrenic polymer foam or foamable composition such as XPS or EPS.

Monomers used in the preparation of styrenic polymers typically are of the formula 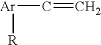
where Ar is an aromatic hydrocarbyl group and R is a hydrogen atom or a methyl group. Examples of such styrenic polymers are homopolymers of styrene, alpha-methylstyrene, o-methylstyrene, m-methylstyrene, p-methylstyrene, ar-ethylstyrene, ar-vinylstyrene, ar-chlorostyrene, ar-bromostyrene, ar-propylstyrene, ar-isopropylstyrene, 4-tert-butylstyrene, o-methyl-alpha-methylstyrene, m-methyl-alpha-methylstyrene, p-methyl-alpha-methylstyrene, ar-ethyl-alpha-methylstyrene,; and copolymers of two or more of such alkenyl aromatic compounds with minor amounts (by weight) of other readily polymerizable olefinic compounds such as, for example, methylmethacrylate, acrylonitrile, maleic anhydride, citraconic anhydride, itaconic anhydride, acrylic acid, vinyl carbazole, and rubber reinforced (either natural or synthetic) styrenic polymers. Preferably at least 80 weight % of styrene is incorporated in the styrenic copolymers. Thus in each and every embodiment of this invention set forth anywhere in this disclosure, the styrenic polymer preferably comprises polystyrene or a styrenic copolymer in which at least 80 wt % of the polymer is formed from styrene. It is also possible to flame retard blends of styrenic polymer with one or more non-styrenic polymers such as poly(2,6-dimethylphenylene oxide), poly(2,6-dimethylphenylene oxide)-co-(2,3,6-trimethylphenylene oxide), and similar polyphenylene oxide polymers; polycarbonates; polysulfones; polyesters; and other suitable polymers. Such base polymer blends (i.e., without reference to additives) are preferably formed from about 40 to about 99.9 weight percent of styrenic polymer, the balance (to 100 weight percent) being one or more of such other polymers. Methods for preparing styrenic homopolymers, styrenic copolymers, impact-modified styrenic polymers, and styrenic polymer blends with other thermoplastic polymers are known and reported in the literature.

The styrenic polymers can be a substantially thermoplastic linear polymer or a mildly cross-linked styrenic polymer. Among suitable procedures that can be used for producing mildly cross-linked styrenic polymers for use in foaming operations are those set forth, for example, in U.S. Pat. Nos. 4,448,933; 4,532,264; 4,604,426; 4,663,360 and 4,714,716, all disclosures of which that describe how at least one mildly cross-linked styrenic polymer for use in foaming operations can be produced, are incorporated herein by reference.

From the foregoing it can be seen that in general, the substrate polymer is comprised of an olefinic polymer or a styrenic polymer, or blend or alloy of either such type of polymer with another type of thermoplastic polymer wherein at least about 30 wt % of the blend or alloy is at least one olefinic polymer. The olefinic polymers themselves are predominately polymers that are devoid of aromaticity, that are formed from open chain monomers that have one or more polymerizable olefinic groups in the molecule, and that optionally are substituted by functional groups such as are referred to above. In contrast, the styrenic polymers themselves are predominately polymers formed from at least one styrenic monomer of the formula given above and are normally composed of a backbone with aromatic side chains but which may be mildly cross-linked.

Other Details

In the additive compositions of this invention and in the styrenic and olefinic polymer compositions of this invention, the proportions of components (A) and (B) are typically such that the weight ratio of (A)/(B) is in the range of about 80/20 to about 99.5/0.5, preferably in the range of about 90/10 to about 99/1, and more preferably in the range of about 95/5 to about 98.5/1.5. In the preferred additive compositions of this invention and in the preferred styrenic and olefinic polymer compositions of this invention in which component (C) is also utilized, the amount of the hydrotalcite and/or zeolite and/or tin stabilizer, is representing 0.1 to 20% by weight of the amount of Component (A). More preferably the hydrotalcite and/or zeolite and/or tin stabilizer represent 0.2 to 15% by weight of component (A). The most preferred concentration of the hydrotalcite and/or zeolite and/or tin stabilizer is 0.25 to 10% by weight of component (A).

Methods for producing styrenic foams including both XPS foams and EPS foams are well known and reported in the literature. Thus any suitable method can be employed as long as the resultant foam is flame retarded by use of a flame retardant amount of a blend of component (A) and (B) in a suitable (A)/(B) weight ratio such as given above. A flame retardant amount is an amount which provides a measurable improvement in flammability resistance in test specimens if subjected to the standard Limited Oxygen Index test procedure as set forth in ASTM Standard Test Method D2863-87. Preferably, the amount of component (A) in whatever chemical structure(s) and/or form(s) it exists or forms in the styrenic polymer provides test specimens which exhibit a LOI (Limited Oxygen Index) of at least 23% oxygen, and thus by “a flame retardant amount” is meant that the polymer contains an amount of component (A) sufficient to provide an LOI of at least 23% oxygen. Typically the amount used provides a bromine content in the foam in range of about 0.2 to about 4 wt % based on the total weight of the foam composition. Preferably the amount used provides a bromine content in the foam in the range of about 0.5 to about 2.5 wt % based on the total weight of the foam composition.

Thus, flame retarded extruded styrenic polymer foams such as XPS can be prepared conveniently and expeditiously by use of known procedures. For example one useful general procedure involves heat plastifying a thermoplastic styrenic polymer composition of this invention in an extruder. From the extruder the heat plastified resin is passed into a mixer, such as a rotary mixer having a studded rotor encased within a housing which preferably has a studded internal surface that intermeshes with the studs on the rotor. The heat-plastified resin and a volatile foaming or blowing agent are fed into the inlet end of the mixer and discharged from the outlet end, the flow being in a generally axial direction. From the mixer, the gel is passed through coolers and from the coolers to a die which extrudes a generally rectangular board. Such a procedure (except for the use in the styrenic polymer composition of the flame retardant(s) and acrylate or methacrylate stailizer(s) of the present invention) is described for example in U.S. Pat. No. 5,011,866. Other procedures include use of systems in which the foam is extruded and foamed under sub-atmospheric, atmospheric and super-atmospheric pressure conditions. As indicated in U.S. Pat. No. 5,011,866, one useful sub-atmospheric (vacuum) extrusion process is described in U.S. Pat. No. 3,704,083. That process is indicated to be of advantage in that the type of vacuum system therein described does not require a low-permeability/high permeability blowing agent mixture, due to the influence of the vacuum on the foaming process. Other disclosures of suitable foaming technology appear, for example, in U.S. Pat. Nos. 2,450,436; 2,669,751; 2,740,157; 2,769,804; 3,072,584; and 3,215,647. All disclosures in any of the patents identified in this paragraph, which disclosures describe how at least one extruded styrenic polymer foam can be formed, are incorporated herein by reference.

The styrenic polymer compositions of this invention can also be used in the production of expandable beads or granules having enhanced flame resistance. In general, these materials may be produced by use of equipment, process techniques and process conditions previously developed for this purpose, since the flame retardant compositions of this invention do not materially affect adversely the processing characteristics and overall properties of the styrenic polymer employed. Also, known and established techniques for expanding the expandable beads or granules, and for molding or forming the further expanded beads or granules into desired products are deemed generally applicable to the expandable beads or granules formed from the styrenic polymer compositions of this invention. Suitable technology for producing expandable beads or granules is disclosed, for example, in U.S. Pat. Nos. 2,681,321; 2,744,291; 2,779,062; 2,787,809; 2,950,261; 3,013,894; 3,086,885; 3,501,426; 3,663,466; 3,673,126; 3,793,242; 3,973,884; 4,459,373; 4,563,481; 4,990,539; 5,100,923; and 5,124,365; all disclosures of which that describe how expandable beads or granules are produced, are fully incorporated herein by reference. Procedures for converting expandable beads or granules of a styrenic polymer to at least one foamed shape or foamed article are described, for example, in U.S. Pat. Nos. 3,674,387; 3,736,082; and 3,767,744; all disclosures of which that describe how expandable beads or granules are converted into at least one foamed shape or at least one foamed article, are incorporated herein by reference.

Blowing agents for use in forming polymer foams are well known in the art, and can be used. Preferred are certain chlorofluoro carbons or alternatively volatile aliphatic or cycloaliphatic hydrocarbons such as pentane, isopentane, cyclopentane, hexane, isohexane, cyclohexane, and mixtures of two or more volatile hydrocarbons of this type. Typically such hydrocarbons contain in the range of about 4 to about 6 carbon atoms in the molecule.

To form the flame retardant additive compositions of this invention various methods and mixing or compounding equipment can be used. For example when preparing the product in pellet form, a twin-screw compounder can be employed using an appropriate temperature profile for the particular component (B) acrylate or methacrylate polymer(s) being used. At least one component (A) bromine-containing flame retardant is added to the molten component (B) polymer in the compounder. Typically the screw profile would include several kneading blocks and backward mixing elements to ensure thorough mixing of the components. The melt is extruded through a die-faced cutting device to form the pelletized product. If desired, the additive components used can be mixed in a batch or continuous mixing chamber and then introduced into the extruder. Continuous mixers of this type typically have an upstream twin screw section that subjects the components to intensive mixing and a downstream conveyor section which can introduce the mixture into an extruder and die-faced pelletizer.

Similarly, when forming pelletized masterbatch compositions of this invention, various known pelletizing procedures can be utilized. Typically, such operations involve forming a dried mixture of components (A) and (B), and preferably (C) as well. Such dried mixture can be in the form of a powder blend or preformed pellets. The dried mixture is then mixed, typically in an extruder at an elevated temperature, with a styrenic or olefinic polymer to form a melt which is extruded through a die plate with suitable-sized holes to produce one or more strands (spaghetti) which are sliced into pellets of desired length. Such pellets are typically cylindrical with a cross section size and shape determined by the characteristics of the holes in the die plate.

As noted above, tetrabromocyclooctane and dibromoethyl-dibromocyclohexane are preferred flame retardants for use in the practice of this invention. Among desired commercial uses for tetrabromocyclooctane and dibromoethyl-dibromocyclohexane is as a flame retardant for use in expanded or foamed styrenic polymer compositions, such as XPS and EPS. However, the target temperature of 200° C. for XPS applications is much further away for tetrabromocyclooctane and dibromoethyl-dibromocyclohexane than for the more commonly-used flame retardant, hexabromocyclododecane. Until relatively recently, the possible use of either tetrabromocyclooctane or dibromoethyl-dibromocyclohexane as a flame retardant for XPS-type products was not considered feasible. Even in EPS applications where the maximum temperature encountered is typically about 130° C., tetrabromocyclooctane and dibromoethyl-dibromocyclohexane were deemed usable only in the second stage of a two-stage process because neither tetrabromocyclooctane nor dibromoethyl-dibromocyclohexane could survive the full polymerization process which usually lasts for several hours at about 130° C. Despite these hurdles, this invention has now made it possible to use either or both of tetrabromocyclooctane and dibromoethyl-dibromocyclohexane to effectively flame retard XPS and EPS types of styrenic polymers without fear of thermal degradation.

In formulating the above blends and formulations, components (A) and (B), and preferably (C) as well, can be blended the thermoplastic polymer or mixed with components of the foamable formulation individually and/or in any partial blend(s) of the components being used. However in order to minimize the possibility of blending errors or lack of substantial uniformity from formulation to formulation, and to facility the preparation of such formulations, it is preferable to employ a preformed blend of components (A) and (B), and preferably (C) as well, in which the components are already in the appropriate proportions.

The flame retardant quantity of components (A) and (B), and preferably (C) as well, proportioned as described above, can vary depending for example upon the particular flame retardant composition of this invention being used, the particular styrenic polymer in which the particular flame retardant additive composition of this invention is used, the service to which the ultimate molded or extruded or foamed article or shape is to be put, the thickness of the molded part, whether or not the styrenic polymer or styrenic polymer formulation contains a flame retardant synergist, e.g. Sb₂O₃, or sodium antimonate (Na₂Sb₂O₆), and any adverse effect that the compound may have on the physical properties of the resultant styrenic polymer foam. Generally, an empirical approach is relied upon in the art for determining the flame retardant quantity which best suits the particular needs for the intended usage of the end product. Generally speaking, the flame retardant quantity in a substrate polymer will typically be such that the substrate polymer contains in addition to component (B) and preferably (C) as well, in the range of about 0.5 to about 2.5 weight % of bromine as component (A).

To produce expanded, i.e., foamed articles, from a styrenic polymer, the flame retardant quantity of a combination of components (A) and (B) proportioned as described above is typically in the range of about 0.7 to about 3.5 weight percent.

It will be appreciated that the proportions given herein for the specified components, although typical, are nonetheless approximate, as departures from one or more of the foregoing ranges are permissible whenever deemed necessary, appropriate or desirable in any given situation in order to achieve the desired flame retardancy. Thus to achieve the optimum combination of flame retardancy, thermal stability, and other properties, a few preliminary tests with the materials to be used is usually a desirable way to proceed in any given situation.

To form flame retardant extruded expanded styrenic polymers such as XPS, a flame retardant quantity of (A) and (B), preferably along with (C) as well, in proportions as described above is typically mixed with the styrenic polymer and a blowing agent in an extruder, and the resultant mixture is extruded through a die providing the desired dimensions of the product, such as boards of various thicknesses and one of several different widths. The combination of (A) and (B), and preferably along with (C) as well, proportioned as described above is highly advantageous for use in this process because such flame retardant combination has good thermal stability and exhibits low corrosivity toward metals with which the hot blend comes into contact in the process. Also the flame retardant combination mixes well with the other components in the extruder.

Flame retardant expandable styrenic polymers such as EPS are typically made pursuant to this invention by suspension polymerization of a mixture of styrene monomer(s) and a flame retadant quantity of a combination of (A) and (B), proportioned as described above in water to form beads of styrenic polymer. The small beads (e.g., averaging about 1 mm in diameter) so formed are then pre-expanded with steam and then molded again with steam to produce large blocks which can be of various large sizes, that will then be cut in the desired dimensions. For use in this process the combination of (A) and (B), proportioned as described above, is desirable because it has sufficient solubility in the styrenic monomer(s), especially in styrene.

Other Additive Components

The thermoplastic olefinic or styrenic polymer compositions of this invention may contain other additives such as, for example, antioxidants, metal scavengers or deactivators, pigments, fillers, dyes, anti-static agents, processing aids, and other additional thermal stabilizers. Any additive which would materially detract from one or more of the advantageous performance properties of the composition of this invention when devoid of such additive, should not be included in the composition.

In the case of foamed or foamable styrenic polymer compositions such as XPS or EPS-type compositions, such ingredients as extrusion aids (e.g., barium stearate or calcium stearate), peroxides like dicumylperoxide or C-C synergists like dicumyl, acid scavengers (e.g., magnesium oxide or tetrasodium pyrophosphate), dyes, pigments, fillers, stabilizers, antioxidants, antistatic agents, reinforcing agents, and the like can be included. If desired, nucleating agents (e.g., talc, calcium silicate, or indigo) to control cell size can be included in the styrenic polymer compositions used in producing the flame retardant expanded or foamed styrenic polymers of this invention. Each of the particular ancillary materials selected for use in the foam compositions of this invention is used in conventional amounts, and should be selected such that no such material materially affects adversely the properties of the finished polymer foam composition for its intended utility.

Conventional amounts of the above other ingredients can be used in the various polymer compositions of this invention. Such amounts are generally known in the art but in any doubtful case it is prudent to follow the suggestions of the supplier of any given additive. Optimization will typically involve only a few relatively simple preliminary experiments.

The following examples illustrate the practice and features of this invention. These examples are not intended to limit, and should not be construed as limiting, the scope of the invention.

### EXAMPLE 1

A composition of this invention made up of a component (A) flame retardant and a component (B) thermal stabilizer was produced. This was done using a Haake rheomix 600 mixing device. In particular, 12 g of a commercially-available ethylene-n-butylacrylate copolymer having a melting point of about 67° C. was introduced into the mixing device in which the chamber had been heated to 75° C. and with the rotor speed set at 100 rpm. After 1 minute of residence time under these conditions, 108 g of dibromoethyl-dibromocyclohexane (SAYTEX® BCL-462; Albemarle Corporation) was added to the molten contents of the chamber. The mixing procedure was continued until all of the BCL-462 was completely molten and the blends became translucent without any white spots, which typically involves mixing for up to about 5 minutes. Then, the chamber is cooled down to below 40° C. with the rotors continuing to run so as to avoid segregation of the ingredients in the mixture. Once the mixture has been cooled to below 40° C., the rotors are stopped and the chamber is opened to collect the resultant composition.

### EXAMPLE 2

Dynamic TGA evaluations were performed on the compositions described in Table 1 and as prepared as in Example 1 wherein dibromoethyl-dibromocyclohexane (SAYTEX® BCL-462; Albemarle Corporation) is signified by “BCL-462” and the commercially-available ethylene-n-butylacrylate copolymer having a melting point of about 67° C. is signified by “EBA” (Atofina Chemicals). These TGA evaluations were performed over the range of 30 to 750° C. at a rate of temperature increase of 10° C. per minute. Table 1 wherein the percentages of the blends are by weight, summarizes the results obtained in these tests.

TABLE 1

| | | BCL-462 90 wt % |
|---|---|---|
| T° C. Weight Loss % | BCL-462 100 wt % | EBA 10 wt % |
| 1% | 131.24 | 154.16 |
| 5% | 159.53 | 192.63 |
| 10% | 181.95 | 206.81 |
| 20% | 205.86 | 221.60 |

### EXAMPLE3

Dynamic TGA evaluations were performed as in Example 2 on the compositions described in Table 2 wherein tetrabromocyclooctane (SAYTEX® BC-48; Albemarle Corporation) is signified by “BC-48” and the commercially-available ethylene-n-butylacrylate copolymer having a melting point of about 67° C. is signified by “EBA” (Atofina Chemicals). The results are summarized in Table 2 in which the percentages of the blends are on a weight basis.

TABLE 2

| T° C. Weight | | BC-48 90 Wt % |
|---|---|---|
| Loss % | BC-48 100 wt % | EBA 10 wt % |
| 1% | 134.90 | 160.89 |
| 5% | 150.06 | 199.04 |
| 10% | 169.74 | 211.90 |
| 20% | 191.81 | 222.85 |

### EXAMPLE 4

A group of tests were conducted to demonstrate the advantageous flame retardancy results achievable from use of the flame retardant blends of this invention in styrenic polymers. The styrenic polymer used was Styron 678E polystyrene (The Dow Chemical Company), and the flame retardant compositions of this invention were mixtures of SAYTEX BCL-462 flame retardant (dibromoethyl-dibromocycloethane) thermally stabilized with different acrylate or methacrylate stabilizers of this invention. These thermal stabilizing polymers used in the respective compositions were:
a) EBA, an ethylene-n-butylacrylate containing 33-37 wt % of n-butylacrylate and having a melting point of about 67° C. (Lotryl 35BA40 polymer; Atofina Chemicals);
b) 4720, an ethylene-ethylacrylate-maleic anhydride terpolymer containing 30 wt % of ethyl acrylate, 0.3 wt % of maleic anhydride, with the balance being ethylene, and having a melting point of 69° C. (Lotader 4720 polymer; Atofina Chemicals);
c) AX8900, an ethylene-methylacrylate-glycidyl methacrylate terpolymer containing 25 wt % of methyl acrylate, 8 wt % of glycidyl methacrylate, with the balance being ethylene, and having a melting point of 60° C. (Lotader AX8900 polymer; Atofina Chemicals); and
d) HP4051, an ethylene-n-butylacrylate-carbon monoxide copolymer containing >98 wt % of ethyleneacrylate copolymer, <0.5 wt % of n-butylacrylate, and <1 wt % of other component(s), and having a melting point of 59° C. (Elvaloy HP4051 polymer modifier; DuPont).

The compositions identified in Table 3 below were compounded using a Haake Rheomix 600 machine in which the mixing chamber was heated at 150° C. and the rotor speed was set at 100 rpm. A portion of the GPPS (Styron 678E polystyrene; The Dow Chemical Company) was charged to the mixing chamber first. After about 2 minutes, a blend of the BCL-462 and the respective acrylate or methacrylate polymer was added together with the remainder of the GPPS. After several more minutes of mixing the rotors were stopped and the compounded blend was cooled to room temperature. The test specimens were formed by placing about 40-45 g of the compounded composition into a 130×70×2 mm insert. The composition in the insert is then melted and pressed for about 4 minutes and then pressed between heated platens at 180° C. at 200 kN for another 4 minutes. The resultant compressed plaque is then cooled at 20° C. for 8 minutes. Test specimens of 10×70 mm are then cut from the compressed plaque for use in conducting LOI measurements. Observations were also made of the color characteristics of the test specimens after exposure to the elevated temperatures.

TABLE 3

| | Loading | Br Content | | Color of |
|---|---|---|---|---|
| Flame Retardant | (%) | (%) | LOI | Compound |
| BCL-462 | 3.00 | 2.25 | 24.8 | Brown |
| 90 Wt % BCL-462 + | 3.30 | 2.25 | 25.1 | White/translucent |
| 10 wt % EBA | | | | |
| 90 Wt % BCL-462 + | 3.30 | 2.25 | 24.4 | White/translucent |
| 10 Wt % 4720 | | | | |
| 90 Wt % BCL-462 + | 3.30 | 2.25 | 25.0 | White/translucent |
| 10 wt % AX8900 | | | | |
| 95 wt % BCL-462 + | 3.15 | 2.25 | 24.7 | Colorless |
| 5 wt % AX8900 | | | | |
| 90 wt % BCL-462 + | 3.30 | 2.25 | 25.3 | White/translucent |
| 10 wt % HP4051 | | | | |

### EXAMPLE 5

The procedures of Example 4 were repeated except that the flame retardant used was HP-900, hexabromocyclododecane (SAYTEX HP-900 flame retardant; Albemarle Corporation) and the stabilizer used was an ethylene-methylacrylate-glycidyl methacrylate terpolymer (AX8900). A control run was also made using the flame retardant itself without any thermal stabilizer. Table 4 summarizes the results of these tests.

TABLE 4

| Flame Retardant | Loading (%) | Br (%) | LOI | Color of Compund |
|---|---|---|---|---|
| HP-900 | 3.00 | 2.25 | 24.9 | Discolored/light |
| | | | | brown |
| 90 wt % HP-900 + | 3.30 | 2.25 | 25.0 | White/translucent |
| 10 wt % AX8900 | | | | |

### EXAMPLE 6

A series of runs were made to illustrate the flame retardancy and thermal stability results achievable in the practice of preferred embodiments of the invention in which a hydrotalcite was included in the compositions. Preblends were prepared composed of 95 wt % of BC-462 and 5 wt % of AX8900 (M/B 95/5) and 90 wt % of BC-462 and 10 wt % of AX8900 (M IB 90/10). Flame retardant, thermal stabilized GPPS test specimens were prepared using procedures generally similar to those described in Example 4 above, except that one of the preformed preblends was used in forming the test specimens. Runs were performed with and without addition of DHT-4A hydrotalcite (Kyowa Chemical Co.), and LOI determinations and color observations on the plaques after thermal exposure under pressure were made. Table 5 identifies the compositions tested and summarizes the results obtained thereon.

TABLE 5

| | | Br content | | Color of |
|---|---|---|---|---|
| Flame Retardant | Loading (%) | (%) | LOI | Compound |
| M/B 95/5 | 3.00 | 2.14 | 24.5 | White/translucent |
| M/B 90/10 | 3.00 | 2.03 | 24.8 | White/translucent |
| M/B 95/5 + 2% | 2.94 + 0.06 | 2.09 | 25.1 | White/translucent |
| DHT-4A | | | | |
| M/B 95/5 + 1% | 2.97 + 0.03 | 2.12 | 25.0 | White/translucent |
| DHT-4A | | | | |
| M/B 95/5 + 0.5% | 2.99 + 0.02 | 2.13 | 24.9 | White/translucent |
| DHT-4A | | | | |
| M/B 95/5 + 0.25% | 2.99 + 0.01 | 2.13 | 25.1 | White/translucent |
| DHT-4A | | | | |
| M/B 90/10 + 0.25% | 2.99 + 0.01 | 2.02 | 24.7 | White/translucent |
| DHT-4A | | | | |
| M/B 90/10 + 0.5% | 2.99 + 0.02 | 2.01 | 25.2* | White/translucent |
| DHT-4A | | | | |
| M/B 90/10 + 1% | 2.97 + 0.03 | 2.00 | 25.1 | White/translucent |
| DHT-4A | | | | |
| M/B 90/10 + 2% | 2.94 + 0.06 | 1.98 | 25.2 | White/translucent |
| DHT-4A | | | | |
| 98% BCL-462 + | 3.00 | 2.21 | 25.6 | White/translucent |
| 2% DHT-4A | | | | |
| 99% BCL-462 + | 3.00 | 2.23 | 25.3 | White/translucent |
| 1% DHT-4A | | | | |
| 99.5% BCL-462 + | 3.00 | 2.24 | 25.1 | Brown stripes |
| 0.5% DHT-4A | | | | |
| 99.75% BCL-462 + | 3.00 | 2.24 | 24.9 | Discolored/brown |
| 0.25% DHT-4A | | | | |

*Average of two runs, one being 25.4 and the other being 25.0.

### EXAMPLE 7

The procedure of Example 6 was repeated with the exception that the thermal stabilizer employed was zeolite-A or dibutyltinmaleate (DBTM). Table 6 identifies the compositions and results of these tests.

TABLE 6

| | | Br Content | | Color of |
|---|---|---|---|---|
| Flame Retardant | Loading (%) | (%) | LOI | Compound |
| M/B 95/5 | 3.00 | 2.14 | 24.5 | White/translucent |
| M/B 90/10 | 3.00 | 2.03 | 24.8 | White/translucent |
| 95% BCL-462 + | 3.00 | 2.14 | 24.6 | Brown stripes |
| 5% zeolite-A | | | | |
| M/B 95/5 + 5% | 2.85 + 0.15 | 2.03 | 24.8 | White/translucent |
| zeolite-A | | | | |
| M/B 90/10 + 5% | 2.85 + 0.15 | 1.92 | 24.8 | White/translucent |
| zeolite-A | | | | |
| 98% BCL-462 + | 3.00 | 2.21 | 24.7 | Brown stripes |
| 2% DBTM | | | | |
| M/B 95/5 + 2% | 2.94 + 0.06 | 2.09 | 24.9 | White/translucent |
| DBTM | | | | |
| M/B 90/10 + 2% | 2.94 + 0.06 | 1.98 | 24.6 | White/translucent |
| DBTM | | | | |

The data in Tables 5 and 6 indicate that synergistic improvements in LOI can be achieved pursuant to this invention in that LOI values are either maintained at essentially the same levels or are increased while bromine contents are decreased.

### EXAMPLE 8

A suspension polymerization of styrene in the presence of either BCL-462 or BCL-462+10% EBA, an ethylene-n-butylacrylate copolymer (Lotryl 35BA40 polymer; Atofina Chemicals). 0.28 G of polyvinyl alcohol (PVA) was dissolved in 200 g of deionized water and poured into a 1-liter glass vessel. Separately, a solution was formed from 0.64 g of dibenzoyl peroxide (75% in water), 0.22 g of dicumyl peroxide, and 1.4 g of BCL-462 or 1.54 g of BCL-462 with 10% EBA in 200 g styrene. This latter solution was poured into the vessel containing the PVA solution. The resultant liquid was charged to a polymerization reactor and mixed with an impeller-type stirrer set at 100 rpm in the presence of a baffle to generate shear in the reactor. The mixture was then subjected to the following heating profile:
From 20 to 90° C. in 45 minutes and help at 90° C. for 4.25 hours (first stage operation);
From 90 to 130° C. in 1 hour and held at 130° C. for 2 hours (second stage operation); and
From 130 to 20° C. in 1 hour.
   At the end of the first stage the reactor was pressurized with nitrogen (2 bars). Once cooled down, the reactor was emptied and the mixture was filtered. The flame retardant beads formed in the process were dried at 60° C. overnight and then sieved to determine bead size distribution.

As shown by the results summarized in Table 7, the inclusion of the EBA did not affect the conversion or particle size distribution of the products in a materially adverse manner.

TABLE 7

| | BCL-462/ | BCL-462 + 10% EBA/ |
|---|---|---|
| Flame Retardant | 0.7% loading | 0.77% loading |
| Conversion (%) | 92.2 | 90.2 |
| Particle Size Distribution (%) | | |
| >2 mm | 4.23 | 3.48 |
| 1.4 mm to 2 mm | 29.90 | 19.87 |
| >1 mm to 1.4 mm | 48.80 | 52.14 |
| >710 μm to 1 mm | 12.39 | 18.97 |
| >500 μm to 710 μm | 3.06 | 3.85 |
| >250 μm to 500 μm | 1.62 | 1.69 |

### EXAMPLE 9

Another advantage of using a preformed additive composition of this invention in forming polymer blends of components (A) and (B) as compared to blending these components separately with the base polymer is illustrated by this group of LOI tests. In particular, two preformed additive compositions of this invention were prepared from BCL-462 and AX8900 as described in Example 1 which were subsequently blended with two different portions of the same additive-free polystyrene to produce two flame retardant polymer compositions of this invention. Two other comparable flame retardant polymer compositions of this invention were prepared using additional portions of the same polystyrene, additional portions of BCL-462 and AX8900, and the same blending conditions except that the BCL-462 and AX8900 were blended separately in powder form with two separate portions of the polystyrene. The test specimens so formed were subjected to LOI determinations. The makeup of the compositions and the LOI test results are summarized in Table 8.

TABLE 8

| | Component | Additive | Bromine | |
|---|---|---|---|---|
| | Blending | Loading, | Content, | |
| Components & Ratio | Method | % | % | LOI |
| 90/10 BCL-462/AX8900 | Used as | 3.00 | 2.03 | 25.1 |
| | Preformed | | | |
| | Blend | | | |
| BCL-462/AX8900 (90/10) | Blended | 3.00 | 2.03 | 24.4 |
| | Separately | | | |
| 95/5 BCL-462/AX8900 | Used as | 3.00 | 2.14 | 25.3 |
| | Preformed | | | |
| | Blend | | | |
| BCL-462/AX8900 (95/5) | Blended | 3.00 | 2.14 | 24.6 |
| | Separately | | | |

### EXAMPLE 10

Two more LOI determinations were performed on flame retardant polystyrene compositions of this invention in a manner similar to Example 9. In this case, two flame retardant polystyrene compositions of this invention containing hydrotalcite were prepared. One sample was formed from a preformed additive made from three components (BCl-462, AX8900, and DHT-4A). This preformed additive was prepared using the procedure of Example 1 except that 2.45 g of DHT-4A and the 108 g of BCL-462 were added to the molten AX8900. The other sample was formed from a preformed additive made from components BCL-462 and AX8900, with the DHT being blended into the polymer separately from the preformed additive mixture of BCL-462 and AX8900. Table 9 summarizes the makeup of the compositions and the LOI results obtained. In Table 9 the blending method in which a preformed additive of this invention made from all three of BCl-462, AX8900, and DHT-4A is referred to as “Preformed 3”, whereas the other blending method is referred to as “Preformed 2+1”. It will be seen that the additives made by these two methods gave comparable results.

TABLE 9

| | Component | Additive | Bromine | |
|---|---|---|---|---|
| Components & | Blending | Loading, | Content, | |
| Ratio | Method | % | % | LOI |
| 88.2/9.8/2 BCL- | Preformed 3 | 3.00 | 1.98 | 25.1 |
| 462/AX8900/ | | | | |
| DHT-4A | | | | |
| 90/10 BCL-462/ | Preformed 2 + 1 | 2.94 + 0.06 | 1.98 | 25.2 |
| AX8900 + 2% | | | | |
| DHT-4A | | | | |

Components referred to herein by chemical name or formula, whether referred to in the singular or plural, are identified as they exist prior to coming into contact with another substance referred to by chemical name or chemical type (e.g., another component, a solvent, or a polymer). Also, even though reference may have been made herein to substances, components and/or ingredients in the present tense (e.g., “comprises” or “is”), the reference is to the substance, component or ingredient as it existed at the time just before it was first contacted, blended or mixed with one or more other substances, components and/or ingredients in accordance with the present disclosure.

Except as may be expressly otherwise indicated, the article “a” or “an” if and as used herein is not intended to limit, and should not be construed as limiting, a claim to a single element to which the article refers. Rather, the article “a” or “an” if and as used herein is intended to cover one or more such elements, unless the text expressly indicates otherwise.

Each and every patent or publication referred to in any portion of this specification is incorporated in toto into this disclosure by reference, as if fully set forth herein.

All documents referred to herein are incorporated herein by reference in toto as if fully set forth in this document.

This invention is susceptible to considerable variation within the spirit and scope of the appended claims. Therefore the foregoing description is not intended to limit, and should not be construed as limiting, the invention to the particular exemplifications presented hereinabove. Rather, what is intended to be covered is as set forth in the ensuing claims and the equivalents thereof permitted as a matter of law.

1. A flame retardant additive composition having enhanced thermal stability which comprises a blend of (A) at least one bromine-containing flame retardant having at least 4 carbon atoms in the molecule, a total bromine content of at least about 40 wt %, and at least two bromine atoms in the molecule directly bonded to one or more aliphatic or cycloaliphatic carbon atoms, and a thermal stabilizing amount of (B) at least one acrylate or methacrylate polymer that melts within the range of about 50 to about 150° C., the mixture of (A) and (B) having a greater thermal stability than (A) by itself, the amount of (B) used in the blending being not more than about 20 weight percent of the weight of (A) and (B) used in forming the flame retardant additive composition.

2. A composition as in claim 1 wherein said at least one bromine-containing flame retardant has at least 6 carbon atoms in the molecule, a total bromine content of at least about 50 wt %, and at least 4 bromine atoms in the molecule directly bonded to aliphatic or cycloaliphatic carbon atoms.

3. A composition as in claim 1 wherein said at least one bromine-containing flame retardant has at least 8 carbon atoms in the molecule, a total bromine content of at least about 60 wt %, and at least 4 bromine atoms in the molecule directly bonded to aliphatic or cycloaliphatic carbon atoms.

4. A composition as in claim 1 wherein the amounts of (A) and (B) used in said blend correspond to an (A)/(B) weight ratio in the range of about 80/20 to about 99.5/0.5.

5. A composition as in claim 4 wherein said weight ratio is in the range of about 85/15 to about 95/5.

6. A composition as in claim 4 wherein said weight ratio is in the range of about 90/10 to about 92.5/7.5.

7. A composition as in claim 1 wherein said at least one bromine-containing flame retardant consists essentially of (i) at least one bromine-containing aliphatic flame retardant devoid of any aromatic group, or (ii) at least one bromine-containing alicyclic compound devoid of any aromatic group, or (iii) at least one bromine-containing aromatic compound having either or both of homocyclic aromaticity and heterocyclic aromaticity and which has one or more aliphatic moieties and/or alicyclic moieties in the molecule to which at least two bromine atoms are directly bonded, or (iv) any two or all three of (i), (ii), and (iii).

8. A composition as in claim 7 wherein the amounts of (A) and (B) used in said blend correspond to an (A)/(B) weight ratio in the range of about 80/20 to about 99.5/0.5.

9. A composition as in claim 8 wherein said weight ratio is in the range of about 85/15 to about 95/5.

10. A composition as in claim 8 wherein said weight ratio is in the range of about 90/10 to about 92.5/7.5.

11. A composition as in claim 1 wherein said at least one bromine-containing flame retardant consists essentially of tetrabromocyclooctane or dibromoethyl-dibromocyclohexane, or a mixture thereof.

12. A composition as in claim 11 wherein the amounts of (A) and (B) used in said blend correspond to an (A)/(B) weight ratio in the range of about 85/15 to about 95/5.

13. A composition as in claim 11 wherein said weight ratio is in the range of about 90/10 to about 92.5/7.5.

14. A composition as in claim 1 wherein component (B) melts within about 10 centigrade degrees above or below the melting temperature of component (A), with the proviso that:
a) in a case where one such component does not have an ascertainable melting temperature and the other component has an ascertainable melting temperature, the temperature at which said one such component softens or becomes pliable is within about 10 centigrade degrees above or below the melting temperature of said other component; and
b) in a case where neither component (A) nor component (B) has an ascertainable melting temperature, the temperature at which one such component becomes soft and pliable is within about 10 centigrade degrees above or below the temperature at which the other such component becomes soft and pliable.

15. A composition as in claim 14 wherein:
a) said at least one bromine-containing flame retardant consists essentially of (i) at least one bromine-containing aliphatic flame retardant devoid of any aromatic group, or (ii) at least one bromine-containing alicyclic compound devoid of any aromatic group, or (iii) at least one bromine-containing aromatic compound having either or both of homocyclic aromaticity and heterocyclic aromaticity and which has one or more aliphatic moieties and/or alicyclic moieties in the molecule to which at least two bromine atoms are directly bonded, or (iv) any two or all three of (i), (ii), and (iii); and
b) the amounts of (A) and (B) used in said blend correspond to an (A)/(B) weight ratio in the range of about 85/15 to about 95/5.

16. A composition as in claim 15 wherein said weight ratio is in the range of about 90/10 to about 92.5/7.5.

17. A composition as in claim 14 wherein said at least one bromine-containing flame retardant consists essentially of tetrabromocyclooctane or dibromoethyl-dibromocyclohexane, or a mixture thereof and wherein the amounts of (A) and (B) used in said blend correspond to an (A)/(B) weight ratio in the range of about 85/15 to about 95/5.

18. A composition as in claim 17 wherein said weight ratio is in the range of about 90/10 to about 92.5/7.5.

19. A composition as in claim 1 wherein the at least one acrylate or methacrylate polymer that is used in said composition is at least one of the following:
(a) at least one ethylene-C₁₋₄alkyl acrylate copolymer,
(b) at least one ethylene-C₁₋₄alkyl acrylate-maleic anhydride terpolymer,
(c) at least one ethylene-C₁₋₄alkyl acrylate-glycidyl methacrylate terpolymer,
(d) at least one ethylene-C₁₋₄alkyl acrylate-carbon monoxide copolymer.

20. A composition as in claim 1 wherein the at least one acrylate or methacrylate polymer that is used in said composition is at least one of the following:
(a) an ethylene-ethylacrylate-maleic anhydride terpolymer that contains about 30 wt % of ethyl acrylate and about 0.3 wt % of maleic anhydride, and has a melting point of about 69° C.,
(b) an ethylene-methylacrylate-glycidyl methacrylate terpolymer that contains about 25 wt % of methyl acrylate and about 8 wt % of glycidyl methacrylate, and has a melting point of about 60° C.,
(c) an ethylene-n-butyl acrylate-carbon monoxide copolymer having a crystalline melt temperature of about 59° C.,
(d) an ethylene-n-butyl acrylate copolymer having a melting point of about 67° C.

21. A composition as in any of claims 1, 5, 7, 11, 12, 14, 19, or 20 wherein said composition further comprises (C) at least one hydrotalcite, (D) at least one zeolite, (E) at least one tin stabilizer compound, or (F) any two or all three of (C), (D), and (E).

22. A composition as in any of claims 1, 4, 9, 11, 14, 15, 19, or 20 wherein said composition further comprises an amount of (C) at least one hydrotalcite, (D) at least one zeolite, (E) at least one tin stabilizer compound, or (F) any two or all three of (C), (D), and (E), wherein said amount of(C), (D), (E), or (F) is in the range of about 0.1 to about 20% by weight of the weight of component (A).

23. A process of preparing a flame retardant additive composition having enhanced thermal stability which comprises blending together (A) at least one bromine-containing flame retardant having at least 4 carbon atoms in the molecule, a total bromine content of at least about 40 wt %, and at least two bromine atoms in the molecule directly bonded to one or more aliphatic or cycloaliphatic carbon atoms and a thermal stabilizing amount of (B) at least one acrylate or methacrylate polymer that has a melting temperature within the range of about 50 to about 150° C., and wherein (A) and (B) are blended together in proportions such that the (A)/(B) weight ratio of the flame retardant additive is in the range of about 80/20 to about 99.5/0.5.

24. A process as in claim 23 wherein components (A) and (B) are blended together in proportions such that the (A)/(B) weight ratio of the flame retardant additive is in the range of about 85/15 to about 95/5.

25. A process as in claim 24 wherein during and/or after forming the blend, the blend is exposed to a temperature at which component (A) or (B), or each of them, is melted or at least becomes soft and pliable, and wherein subsequently the blend cools or is cooled to ambient room temperature.

26. A process of thermally stabilizing a bromine-containing flame retardant having at least 4 carbon atoms in the molecule, a total bromine content of at least about 40 wt %, and at least two bromine atoms in the molecule directly bonded to one or more aliphatic or cycloaliphatic carbon atoms, which process comprises blending with said at least one flame retardant at least one acrylate or methacrylate polymer that has a melting temperature within the range of about 50 to about 150° C. in amount sufficient to thermally stabilize said at least one flame retardant, said amount being such that not more than about 20 weight percent of the blend of said at least one flame retardant and said polymer is from said polymer.

27. A process as in claim 26 wherein said amount is such that said blend has a weight ratio of said at least one flame retardant to said polymer in the range of about 85/15 to about 95/5.

28. A process as in claim 26 wherein said amount is such that said blend has a weight ratio of said at least one flame retardant to said polymer in the range of about 90/10 to about 92.5/7.5.

29. A process as in claim 26 wherein during and/or after forming the blend, the blend is exposed to a temperature at which component (A) or (B), or each of them, is melted or at least becomes soft and pliable, and wherein subsequently the blend cools or is cooled to ambient room temperature.

30. A process as in claim 26 wherein the at least one acrylate or methacrylate polymer, herein designated (B), has a melting point within about 10 centigrade degrees above or below the melting temperature of said at least one flame retardant, herein designated (A), with the proviso that:
a) in a case where one of (A) and (B) does not have an ascertainable melting temperature and the other of (A) and (B) has an ascertainable melting temperature, the temperature at which said one of (A) and (B) softens or becomes pliable is within about 10 centigrade degrees above or below the melting temperature of said other of (A) and (B); and
b) in a case where neither (A) nor (B) has an ascertainable melting temperature, the temperature at which one of (A) and (B) becomes soft and pliable is within about 10 centigrade degrees above or below the temperature at which the other of (A) and (B) becomes soft and pliable.

31. A process as in claim 26 wherein the at least one acrylate or methacrylate polymer that is used in said composition is at least one of the following:
(i) at least one ethylene-C₁₋₄alkyl acrylate copolymer,
(ii) at least one ethylene-C₁₋₄alkyl acrylate-maleic anhydride terpolymer,
(iii) at least one ethylene-C₁₋₄alkyl acrylate-glycidyl methacrylate terpolymer,
(iv) at least one ethylene-C₁₋₄alkyl acrylate-carbon monoxide copolymer.

32. A process as in claim 26 wherein the at least one acrylate or methacrylate polymer that is used in said composition is at least one of the following:
(a) an ethylene-ethylacrylate-maleic anhydride terpolymer that contains about 30 wt % of ethyl acrylate and about 0.3 wt % of maleic anhydride, and has a melting point of about 69° C.,
(b) an ethylene-methylacrylate-glycidyl methacrylate terpolymer that contains about 25 wt % of methyl acrylate and about 8 wt % of glycidyl methacrylate, and has a melting point of about 60° C.,
(c) an ethylene-n-butyl acrylate-carbon monoxide copolymer having a crystalline melt temperature of about 59° C.,
(d) an ethylene-n-butyl acrylate copolymer having a melting point of about 67° C.

33. A process as in any of claims 23-32 wherein at least one of (C) at least one hydrotalcite, (D) at least one zeolite, or (E) at least one tin stabilizer compound, is included in said blend.

34. A flame retardant polymer composition having enhanced thermal stability, which composition comprises at least one olefinic or styrenic polymer with which has been blended separately or in combination (I) a flame retardant amount of (A) at least one bromine-containing flame retardant having at least 4 carbon atoms in the molecule, a total bromine content of at least about 40 wt %, and at least two bromine atoms in the molecule directly bonded to one or more aliphatic or cycloaliphatic carbon atoms, and (II) a thermally stabilizing amount of (B) at least one acrylate or methacrylate polymer that melts in the range of about 50 to about 150° C. such that said composition has a greater thermal stability than the same composition devoid of (B), the amount of (B) used in the blending being not more than about 20 weight percent of the weight of (A) and (B) used in forming the flame retardant polymer composition.

35. A composition as in claim 34 wherein the amounts of (I) and (II) correspond to an (A)/(B) weight ratio in the range of about 80/20 to about 99.5/0.5.

36. A composition as in claim 34 wherein the amounts of (I) and (II) correspond to an (A)/(B) weight ratio in the range of about 85/15 to about 95/5.

37. A composition as in claim 34 wherein the amounts of (I) and (II) correspond to an (A)/(B) weight ratio in the range of about 90/10 to about 92.5/7.5.

38. A composition as in claim 34 wherein said at least one bromine-containing flame retardant has at least 6 carbon atoms in the molecule, a total bromine content of at least about 50 wt %, and at least 4 bromine atoms in the molecule directly bonded to aliphatic or cycloaliphatic carbon atoms.

39. A composition as in claim 34 wherein said at least one bromine-containing flame retardant has at least 8 carbon atoms in the molecule, a total bromine content of at least about 60 wt %, and at least 4 bromine atoms in the molecule directly bonded to aliphatic or cycloaliphatic carbon atoms.

40. A composition as in claim 34 wherein said at least one bromine-containing flame retardant consists essentially of (i) at least one bromine-containing aliphatic flame retardant devoid of any aromatic group, or (ii) at least one bromine-containing alicyclic compound devoid of any aromatic group, or (iii) at least one bromine-containing aromatic compound having either or both of homocyclic aromaticity and heterocyclic aromaticity and which has one or more aliphatic moieties and/or alicyclic moieties in the molecule to which at least two bromine atoms are directly bonded, or (iv) any two or all three of (i), (ii), and (iii).

41. A composition as in claim 34 wherein said at least one bromine-containing flame retardant consists essentially of tetrabromocyclooctane or dibromoethyl-dibromocyclohexane, or a mixture thereof.

42. A composition as in claim 34 wherein component (B) melts within about 10 centigrade degrees above or below the melting temperature of component (A), with the proviso that:
a) in a case where one such component does not have an ascertainable melting temperature and the other component has an ascertainable melting temperature, the temperature at which said one such component softens or becomes pliable is within about 10 centigrade degrees above or below the melting temperature of said other component; and
b) in a case where neither component (A) nor component (B) has an ascertainable melting temperature, the temperature at which one such component becomes soft and pliable is within about 10 centigrade degrees above or below the temperature at which the other such component becomes soft and pliable.

43. A composition as in claim 42 wherein:
a) said at least one bromine-containing flame retardant consists essentially of (i) at least one bromine-containing aliphatic flame retardant devoid of any aromatic group, or (ii) at least one bromine-containing alicyclic compound devoid of any aromatic group, or (iii) at least one bromine-containing aromatic compound having either or both of homocyclic aromaticity and heterocyclic aromaticity and which has one or more aliphatic moieties and/or alicyclic moieties in the molecule to which at least two bromine atoms are directly bonded, or (iv) any two or all three of (i), (ii), and (iii); and
b) the amounts of (I) and (II) correspond to an (A)/(B) weight ratio in the range of about 85/15 to about 95/5.

44. A composition as in claim 43 wherein said weight ratio is in the range of about 90/10 to about 92.5/7.5.

45. A composition as in claim 42 wherein said at least one bromine-containing flame retardant consists essentially of tetrabromocyclooctane or dibromoethyl-dibromocyclohexane, or a mixture thereof and wherein the amounts of (I) and (II) correspond to an (A)/(B) weight ratio in the range of about 85/15 to about 95/5.

46. A composition as in claim 45 wherein the amounts of (I) and (II) used correspond to an (A)/(B) weight ratio in the range of about 90/10 to about 92.5/7.5.

47. A composition as in any of claims 34, 38, 41, or 43 wherein the at least one acrylate or methacrylate polymer that is used in said composition is at least one of the following:
(i) at least one ethylene-C₁₋₄alkyl acrylate copolymer,
(ii) at least one ethylene-C₁₋₄alkyl acrylate-maleic anhydride terpolymer,
(iii) at least one ethylene-C₁₋₄alkyl acrylate-glycidyl methacrylate terpolymer,
(iv) at least one ethylene-C₁₋₄alkyl acrylate-carbon monoxide copolymer.

48. A composition as in any of claims 34, 39, 40, or 41 wherein the at least one acrylate or methacrylate polymer that is used in said composition is at least one of the following:
(a) an ethylene-ethylacrylate-maleic anhydride terpolymer that contains about 30 wt % of ethyl acrylate and about 0.3 wt % of maleic anhydride, and has a melting point of about 69° C.,
(b) an ethylene-methylacrylate-glycidyl methacrylate terpolymer that contains about 25 wt % of methyl acrylate and about 8 wt % of glycidyl methacrylate, and has a melting point of about 60° C.,
(c) an ethylene-n-butyl acrylate-carbon monoxide copolymer having a crystalline melt temperature of about 59° C.,
(d) an ethylene-n-butyl acrylate copolymer having a melting point of about 67° C.

49. A composition as in any of claims 34, 38, 41, or 43 wherein said composition further comprises (C) at least one hydrotalcite, (D) at least one zeolite, (E) at least one tin stabilizer compound, or (F) any two or all three of (C), (D), and (E).

50. A composition as in claim 34 wherein the at least one acrylate or methacrylate polymer that is used in said composition is at least one of the following:
a) at least one ethylene-C₁₋₄alkyl acrylate copolymer,
b) at least one ethylene-C₁₋₄alkyl acrylate-maleic anhydride terpolymer,
c) at least one ethylene-C₁₋₄alkyl acrylate-glycidyl methacrylate terpolymer,
d) at least one ethylene-C₁₋₄ alkyl acrylate-carbon monoxide copolymer; and
wherein said composition further comprises an amount of (C) at least one hydrotalcite, (D) at least one zeolite, (E) at least one tin stabilizer compound, or (F) any two or all three of (C), (D), and (E), wherein said amount of (C), (D), (E), or (F) is in the range of about 0.1 to about 20% by weight of the weight of component (A).

51. A composition as in claim 34 wherein:
A) said at least one bromine-containing flame retardant consists essentially of (i) at least one bromine-containing aliphatic flame retardant devoid of any aromatic group, or (ii) at least one bromine-containing alicyclic compound devoid of any aromatic group, or (iii) at least one bromine-containing aromatic compound having either or both of homocyclic aromaticity and heterocyclic aromaticity and which has one or more aliphatic moieties and/or alicyclic moieties in the molecule to which at least two bromine atoms are directly bonded, or (iv) any two or all three of (i), (ii), and (iii);
B) the amounts of (I) and (II) correspond to an (A)/(B) weight ratio in the range of about 85/15 to about 95/5;
C) component (B) melts within about 10 centigrade degrees above or below the melting temperature of component (A), with the proviso that:
a) in a case where one such component does not have an ascertainable melting temperature and the other component has an ascertainable melting temperature, the temperature at which said one such component softens or becomes pliable is within about 10 centigrade degrees above or below the melting temperature of said other component; and
b) in a case where neither component (A) nor component (B) has an ascertainable melting temperature, the temperature at which one such component becomes soft and pliable is within about 10 centigrade degrees above or below the temperature at which the other such component becomes soft and pliable; and
D) the at least one acrylate or methacrylate polymer that is used in said composition is at least one of the following:
a) at least one ethylene-C₁₋₄alkyl acrylate copolymer,
b) at least one ethylene-C₁₋₄alkyl acrylate-maleic anhydride terpolymer,
c) at least one ethylene-C₁₋₄alkyl acrylate-glycidyl methacrylate terpolymer,
d) at least one ethylene-C₁₋₄alkyl acrylate-carbon monoxide copolymer.

52. A composition as in claim 51 wherein said composition further comprises an amount of (C) at least one hydrotalcite, (D) at least one zeolite, (E) at least one tin stabilizer compound, or (F) any two or all three of (C), (D), and (E), wherein said amount of (C), (D), (E), or (F) is in the range of about 0.1 to about 20% by weight of the weight of component (A).

53. A composition as in claim 51 wherein the at least one acrylate or methacrylate polymer that is used in said composition is at least one of the following:
a) at least one ethylene-C₁₋₄alkyl acrylate copolymer,
b) at least one ethylene-C₁₋₄alkyl acrylate-maleic anhydride terpolymer,
c) at least one ethylene-C₁₋₄alkyl acrylate-glycidyl methacrylate terpolymer,
d) at least one ethylene-C₁₋₄alkyl acrylate-carbon monoxide copolymer; and
wherein said composition further comprises an amount of (C) at least one hydrotalcite, (D) at least one zeolite, (E) at least one tin stabilizer compound, or (F) any two or all three of (C), (D), and (E), wherein said amount of (C), (D), (E), or (F) is in the range of about 0.2 to about 15% by weight of the weight of component (A).

54. A composition as in any of claims 34, 38, 41, 43, or 51 wherein said at least one olefinic or styrenic polymer is at least one impact-modified styrenic polymer.

55. A composition as in claim 54 wherein said at least one impact-modified styrenic polymer is HIPS.

56. A composition as in any of claims 34, 38, 41, 43, or 51 wherein said at least one olefinic or styrenic polymer is a styrenic polymer foam formed from at least one styrenic monomer.

57. A process of preparing a flame retardant thermoplastic olefinic or styrenic polymer composition having enhanced thermal stability which comprises blending together (A) at least one bromine-containing flame retardant having at least 4 carbon atoms in the molecule, a total bromine content of at least about 40 wt %, and at least two bromine atoms in the molecule directly bonded to one or more aliphatic or cycloaliphatic carbon atoms and a thermal stabilizing amount of (B) at least one acrylate or methacrylate polymer that has a melting temperature within the range of about 50 to about 150° C., and wherein (A) and (B) are blended together in proportions such that the (A)/(B) weight ratio of the flame retardant additive is in the range of about 80/20 to about 99.5/0.5.

58. A process as in claim 57 wherein components (A) and (B) are blended together in proportions such that the (A)/(B) weight ratio of the flame retardant additive is in the range of about 85/15 to about 95/5.

59. A process as in claim 58 wherein during and/or after forming the blend, the blend is exposed to a temperature at which component (A) or (B), or each of them, is melted or at least becomes soft and pliable, and wherein subsequently the blend cools or is cooled to ambient room temperature.

60. A process as in any of claims 57-59 further comprising including in said blend (C) at least one hydrotalcite, (D) at least one zeolite, (E) at least one tin stabilizer compound, or (F) any two or all three of (C), (D), and (E).

61. A process of thermally stabilizing a bromine-containing flame retardant thermoplastic olefinic or styrenic polymer composition in which the flame retardant used therein is comprised of at least one bromine-containing flame retardant having at least 4 carbon atoms in the molecule, a total bromine content of at least about 40 wt %, and at least two bromine atoms in the molecule directly bonded to one or more aliphatic or cycloaliphatic carbon atoms, which process comprises blending with said at least one flame retardant at least one acrylate or methacrylate polymer that has a melting temperature within the range of about 50 to about 150° C. in amount sufficient to thermally stabilize said at least one flame retardant, said amount being such that not more than about 20 weight percent of the blend of said at least one flame retardant and said polymer is from said polymer.

62. A process as in claim 61 wherein said amount is such that said blend has a weight ratio of said at least one flame retardant to said polymer in the range of about 85/15 to about 95/5.

63. A process as in claim 61 wherein the at least one acrylate or methacrylate polymer, herein designated (B), used in said blending has a melting point within about 10 centigrade degrees above or below the melting temperature of said at least one flame retardant, herein designated (A), with the proviso that:
a) in a case where one of (A) and (B) does not have an ascertainable melting temperature and the other of (A) and (B) has an ascertainable melting temperature, the temperature at which said one of (A) and (B) softens or becomes pliable is within about 10 centigrade degrees above or below the melting temperature of said other of (A) and (B); and
b) in a case where neither (A) nor (B) has an ascertainable melting temperature, the temperature at which one of (A) and (B) becomes soft and pliable is within about 10 centigrade degrees above or below the temperature at which the other of (A) and (B) becomes soft and pliable.

64. A process as in claim 63 wherein (B) that is used in said process is at least one of the following:
(i) at least one ethylene-C₁₋₄alkyl acrylate copolymer,
(ii) at least one ethylene-C₁₋₄alkyl acrylate-maleic anhydride terpolymer,
(iii) at least one ethylene-C₁₋₄alkyl acrylate-glycidyl methacrylate terpolymer,
(iv) at least one ethylene-C₁₋₄alkyl acrylate-carbon monoxide copolymer.

65. A process as in claim 63 wherein (B) that is used in said process is at least one of the following:
(a) an ethylene-ethylacrylate-maleic anhydride terpolymer that contains about 30 wt % of ethyl acrylate and about 0.3 wt % of maleic anhydride, and has a melting point of about 69° C.,
(b) an ethylene-methylacrylate-glycidyl methacrylate terpolymer that contains about 25 wt % of methyl acrylate and about 8 wt % of glycidyl methacrylate, and has a melting point of about 60° C.,
(c) an ethylene-n-butyl acrylate-carbon monoxide copolymer having a crystalline melt temperature of about 59° C.,
(d) an ethylene-n-butyl acrylate copolymer having a melting point of about 67° C.

66. A process as in any of claims 61-65 wherein at least one of (C) at least one hydrotalcite, (D) at least one zeolite, or (E) at least one tin stabilizer compound, is included in said blend.

67. In a method of preparing an extruded styrenic foam from a foamable molten styrenic polymer mixture, the improvement which comprises including in said mixture a flame retardant amount of (A) tetrabromocyclooctane or dibromoethyl-dibromocyclohexane, or both, and a thermal stabilizing amount of (B) at least one acrylate or methacrylate polymer.

68. In a method of preparing expandable styrenic beads or granules from an expandable styrenic polymer mixture, the improvement which comprises including in said mixture a flame retardant amount of (A) tetrabromocyclooctane or dibromoethyl-dibromocyclohexane, or both, and a thermal stabilizing amount of (B) at least one acrylate or methacrylate polymer.

69. The improvement as in either of claims 67 or 68 wherein (A) and (B) are used in a weight ratio in the range of about 85/5 to about 99.5/0.5.

70. A molded or extruded article formed from a composition of claim 34.

71. A method of producing a flame-retarded article which comprises molding or extruding at a temperature of up to 250° C. a melt blend of a composition of claim 34.
